(19) United States
(12) Patent Application Publication
(10) Pub. No.: US 2008/0263951 A1
(43) Pub. Date: Oct. 30, 2008

(54) Fuel Gas Generation and Supply Device

(76) Inventor: Koji Kobayashi, Toyota-shi (JP)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 12/032,820

(22) Filed: Feb. 18, 2008

(30) Foreign Application Priority Data
Mar. 4, 2007 (JP) 2007-053563

(51) Int. Cl. B01J 7/00

(52) U.S. Cl. 48/61; 422/129

(57) ABSTRACT

A fuel gas generation and supply device includes a reactive liquid storage container, a storage body defining a chamber for a chemical substance that reacts chemically with said liquid to generate a fuel gas, a liquid supply system disposed and arranged for delivering said liquid from the container to the chemical substance in the chamber at a fixed rate, said system including an outlet and a flow constricting segment to control the amount of said liquid supplied to the chemical substance, and a fuel gas delivery system. Such a device solves the problems of adjusting the amount of fuel gas supplied to external applications with very little pressure variation and of the generation of a constant amount of fuel gas continuously, stably, conveniently and inexpensively for enhancing the applicability of fuel cells.

### CROSS REFERENCES TO RELATED APPLICATIONS

None

### BACKGROUND OF THE INVENTION

1. Field of the Invention

The present invention relates to devices for generating fuel gas employing a chemical reaction and supplying a necessary amount of fuel gas at a required time to fuel cells and/or other fuel consuming applications. In particular the present invention relates to such devices that are small, inexpensive, convenient and safe to use.

2. The Prior Art Background

Small, portable, lightweight and inexpensive fuel supply devices that employ chemical reactions to provide a convenient fuel supply for a variety of applications, such as fuel cells and the like are currently known. However, these previously known devices suffer from numerous shortcomings and problems which interfere with the practical usage of the same. Not the least of these problems is the inability of known devices to reliably provide a steady flow of fuel gas at a desired rate. Accordingly there is a present urgent need for the provision of a small, inexpensive, convenient, safe, reusable practical gas generation and supply device which eliminates, or at least minimizes, the shortcomings and problems of these prior devices.

Prior patent publications which relate to known gas generation and supply devices include Published Unexamined Japanese Patent Application No. 2000-161509, Published Unexamined Japanese Patent Application No. 2004-318683, Published Unexamined Japanese Patent Application No. 2005-19517, Published Unexamined Japanese Patent Application No. 2005-93104, Japanese Patent Application No. 2005-321503, Japanese Patent Application No. 2006-082505, and Japanese Patent Application No. 2006-195025.

Prior Non-Patent References which relate to known gas generation and supply devices include Nikkei Electronics, Jun. 6, 2005, No. 901, entitled “Borohydride Enters the Fray for Portable Fuel Cells.”

### SUMMARY OF THE INVENTION

The present invention provides a small, inexpensive, lightweight, convenient, safe, reusable practical gas generation and supply device which uses a chemical reaction to provide a steady, reliable supply of fuel gas to, for example, a fuel cell having an output of several watts or less to several kilowatts or more for a period of at least several hours. Although the device of the present invention is particularly valuable for use in connection with fuel cells, the overall characteristics of the same enhance its general applicability to a variety of applications. In order for the device to supply a steady flow of fuel gas at the correct time and over a long period of time, the rate of the chemical reaction used to generate the fuel gas must be closely controlled and/or the device must include a system capable of discontinuing and/or reducing the fuel gas supply rate temporarily according to the application requirements.

In view of the foregoing, and in accordance with the principles and concepts of the present invention, a first problem recognized is that the control of the amount of fuel gas generated by chemical reaction in a small fuel system, which may be adapted for portable usages in particular, is very difficult and requires different techniques and procedures than those used in connection with large scale plant applications. For example, when the device is to be used in connection with a fuel cell having an output in the several watts to 20 W range, the supply rate of, for example, a 1 molar catalytic solution needed for reaction with a reactive substance to provide a constant chemical reaction rate must be continuously and constantly maintained at approximately 0.1 to 0.5 cc/min. Moreover, in accordance with the invention, it may be desirable to control the amount of fuel gas generated as a function of fuel gas pressure. To do this, a gauge pressure of approximately 10 KPa, for example, is desirable. In addition, it is to be noted that when a flow of 0.1 cc/min. of the catalytic solution is needed, for example, there must be a continuous or controlled demand supply of an amount equivalent to less than two drops of an eye dropper.

A second problem addressed by the invention is the provision of mobile types of gas generation and supply devices which may be distributed widely and which may be reused. Thus, the invention provides a multipurpose device having a small, simple structure that is inexpensive, safe and conveniently applied. In addition there has been an urgent need in the oast for a device having a cost, size and number of parts about the same as a 100 yen gas lighter or less.

To solve the problems mentioned above, a first aspect of the present invention is the provision of a gas generation and supply device provided with a “narrowing means” and/or “flow constricting segment” that is used to control the amount of catalytic solution needed to produce the fuel gas required in accordance with the preferred output of the fuel cell system. Desirably, but not necessarily, such a narrowing means or constricting segment may be located directly at the end of the catalytic solution supply path, that is, the site where fuel gas is generated by the chemical reaction with the reactive chemical substance. Thus, the device of this aspect of the invention is adapted so as to provide a continuous supply of the catalytic solution to the reactive substance in small amounts, for example, at the approximately 0.1 to 0.5 cc/min. flow rate mentioned previously.

A second aspect of the invention is the provision of a gas generation and supply device wherein the narrowing means and/or constricting segment may comprise, for example, a fabric material providing capillary flow and/or a porous material having gas permeability. Such a material not only has the desired flow control characteristics, but the same also may inhibit clogging of the sort caused by the presence of minute particles of foreign matter. Manifestly, such foreign matter may often be present in precision devices, particularly when there is exposure to environments where there are temperature changes because of chemical reactions and the like.

A third aspect of the invention is the provision a gas generation and supply device having a reaction space linked to an outlet for the gas generated by the chemical reaction. Such a space may be at least partially defined by a member adapted to allow fuel gas to pass therethrough while inhibiting passage of liquids such as a catalytic reaction solution. Desirably the space and the member are such that the chemical reaction solution cannot leak out into the generated gas supply outlet even when the gas generation and supply device is used in a variety of angularly different spatial orientations.

A fourth aspect of the invention is the provision a gas generation and supply device which includes a catalytic solution supply path wherein a portion or all of such path comprises an elastic deformable link formed from an elastic member such as, for example, a piece of rubber pipe or the like. Thus, the flow of the catalytic solution toward the reactive substance may be controlled as a function of the pressure of the very low pressure output fuel gas, even when, for example, such fuel gas (which may be for use in a fuel cell system) has a gauge pressure of only approximately 10 KPa. Such an elastic deformable link may be subjected to compression deformation using a thin film elastic deformation element in a manner to control the flow of the catalytic solution. And in this regard it is to be noted that a supply rate of approximately 0.1 to 0.5 cc/min. of a 1 molar catalytic solution is needed, for example, to produce an amount of fuel at a steady chemical reaction rate sufficient for operation of a fuel cell having an output, for example, in the several watt to 20 W range.

A fifth aspect of the invention is the provision of a gas generation and supply device having a flow controlling catalytic solution supply line compression deformation means which includes at least one cylindrical plastic rod shaped protrusion element that facilitates the operation of the compression deformation means and enhances its ability to compress an elastic deformable link, whereby the amount of catalytic solution supplied to the reaction zone may be more precisely controlled.

A sixth aspect of the invention is the provision of a gas generation and supply device including a thin plate shaped means such as, for example, a plastic circular thin plate having greater rigidity than the thin film elastic deformation element so as to more assuredly apply pressure to the elastic link and more effectively compress the latter.

A seventh aspect of the invention is the provision of a gas generation and supply device wherein the “narrowing means” or “flow constricting segment” has a structure that carries out narrowing and/or constriction of the elastic deformable link by sandwiching a rod shaped protruding member between an opposed pair of rod shaped protruding members, and wherein the space established between the pair of rod shaped protruding members is wider than the width of the first mentioned rod shaped protruding member. The rod shaped protruding members cooperate to cause the elastic deformable link to undergo compression deformation sufficient to establish a convex shape therein.

An eighth aspect of the invention is the provision of a gas generation and supply device wherein the elastic deformable link is initially in a partially compressed state, whereby there is no lost motion during the operation of the compression mechanism even when there are fluctuations in the very low pressure of the generated fuel gas whereby the flow rate of the catalytic solution may be precisely controlled.

A ninth aspect of the invention is the provision of a gas generation and supply device wherein the catalytic solution supply system is, for example, constituted of an elastic deforming housing member such as a rubber balloon or the like accommodated in a chemical reaction space disposed in contact with the reactive chemical substance that reacts chemically with the catalytic solution to generate a fuel gas.

### ADVANTAGES OF THE INVENTION

According to the first through third aspects of the invention, the maintenance of a constant fuel gas generation rate and the control of the pressure of the fuel gas thus produced have previously been very difficult to realize with small, inexpensive and simple structures, which necessarily differ greatly from large scale plant devices. However, the present invention affords a gas generation and supply device, for example, for supplying fuel at a constant rate to a fuel cell having an output in the several watt to 20 W range. The device provides a constant, continuous fuel gas output flow of approximately 0.1 to 0.5 cc/min. using, for example, a 1 molar catalyst solution that is supplied to the reactive substance at a constant supply rate to thereby achieve a steady chemical reaction rate. In this latter regard, it is to be noted that when the amount of catalytic solution supplied to the chemical reaction site is 0.1 cc/min., a continuous, steady supply of the same in an amount equivalent to less than two drops from an eyedropper has been achieved. The result is that the invention provides a fuel gas generation and supply device capable of portable use and useful in connection with the low output fuel cells mentioned above. Moreover, the fuel gas generation and supply device of the invention is inexpensive and has a simple, small structure, good responsiveness and a number of components and materials equivalent to, for example, a 100 yen lighter. Moreover, it is not necessary to use complicated special materials in the construction of the device of the invention. In addition, by providing a narrowing means and/or constricting segment at the site of the chemical reaction, variations in dimensions resulting from the length of the catalyst supply path and variations in the supply amount caused by changes in temperature and the like are minimized. Furthermore, refilling of the device with catalytic solution and replenishment of the supply of the chemical substance that generates the fuel gas are conveniently and easily accommodated. Moreover, the device of the invention is environmentally friendly.

According to the fourth through eighth aspects of the invention, when the fuel cell output is, for example, in the several watt to 20 W range, as described above, it is possible to control the low pressure environment therein, which has been described previously, by providing effective and precise compression deformation of the deformable elastic link of the catalytic solution supply system using a thin, round rubber plate. The link may be made up of a pipe constructed of an elastic material such as a rubber, for example, that may be obtained anywhere. Desirably, the mechanism for compressing the link and thereby controlling the flow may comprise, for example, a thin round rubber plate that responds evenly to the extremely low pressure which prevails in the device, and, if necessary, a round plastic sheet. Thus, the amount of fuel gas generated by the device may be controlled even at a fuel gas pressure of, for example, 10 KPa. Furthermore, to achieve sensitive responsiveness in even lower pressure environments, an initial compression deformed state may be established in the deformable elastic link so that there is no free play or lost motion involved in the subsequent displacement of the elastic link.

The ninth aspect of the invention increases the usage efficiency of the system space by housing the liquid storage means in the chemical reaction space and whereby greater compactness is achieved.

### BRIEF DESCRIPTION OF THE DRAWINGS

FIG. 1 is a cross-sectional view of a first embodiment of the present invention which comprises a small fuel gas generation and supply device having a constant chemical reaction rate to facilitate portability;

FIG. 2 is a cross-sectional view of a second embodiment off the invention where the components of the fuel gas generation and supply device of FIG. 1 are in an aligned configuration as opposed to the side-by-side configuration shown in FIG. 1;

FIG. 3 is a cross-sectional view of a third embodiment of the invention where the fuel gas generation and supply device having components similar to those of FIGS. 1 and 2 further includes a flow control mechanism for controlling the amount of catalytic solution supplied to chemical substance that reacts chemically therewith to generate a fuel gas;

FIG. 4 is a cross-sectional view of an alternative form of the mechanism for controlling the amount of catalytic solution supplied to the chemical substance shown in FIG. 3, wherein an elastic deformable pipe link is deformed by compression using a rod shaped protruding part;

FIG. 5 is a cross-sectional view of another alternative form of the mechanism for controlling the amount of catalytic solution supplied to the chemical substance shown in FIG. 3, wherein the elastic deformable pipe link is deformed by compression using three rod shaped protruding parts;

FIG. 6 is a cross-sectional view of yet another alternative form of the mechanism for controlling the amount of catalytic solution supplied to the chemical substance shown in FIG. 3, wherein the space between two of the rod shaped protruding parts of FIG. 5 is larger than the opposing protruding part and the parts are initially arranged so as to cause at least a slight compression deformation of the elastic deformable pipe link;

FIG. 7 is a cross-sectional view of a fourth embodiment of the invention where the mechanism for controlling the amount of catalytic solution supplied to the chemical substance comprises a spring and plunger instead of a elastic deformable pipe link;

FIG. 8 is chart illustrating test data verifying the creation of a constant catalyst supply amount in accordance with the concepts and principles of the present invention and verifying the ultimate effect of the supply amount control system thereon; and

FIG. 9 is a chart of another set of test data verifying that the data of FIG. 8 shows that a constant chemical reaction was actually achieved.

### DETAILED DESCRIPTION OF THE PREFERRED EMBODIMENTS

Preferred embodiments of the present invention are illustrated in the accompanying drawings and explained and clarified with reference to the drawings in the following description.

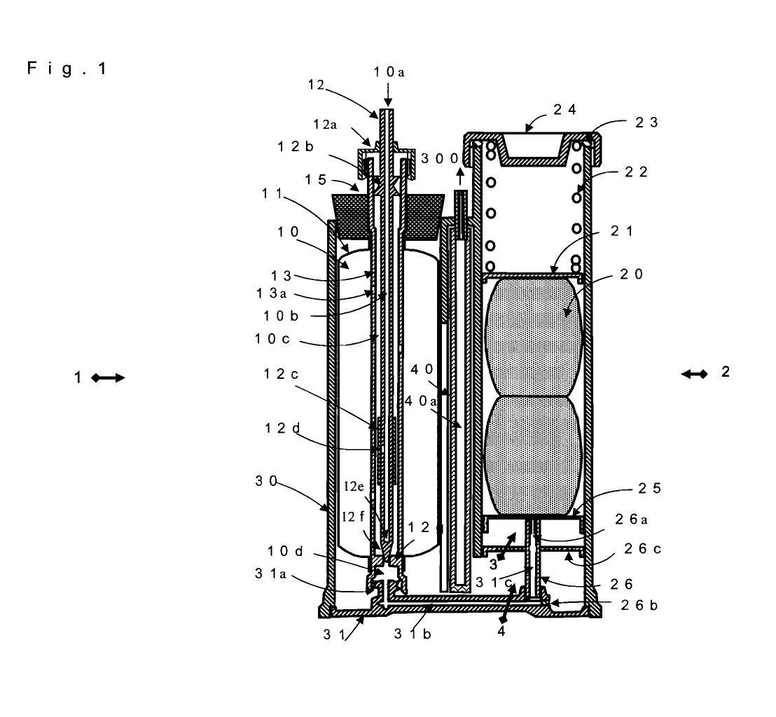

FIG. 1 is a cross-sectional view illustrating a first embodiment of the present invention comprising a small, lightweight hydrogen gas generation and supply device that generates and supplies a constant amount of fuel gas using a chemical reaction. The device of FIG. 1 may be used portably if desired.

As shown in FIG. 1, the gas generation and supply device of the present invention includes four major elements, namely, a reactive liquid storage body or container 1, a gas generation member storage body 2 defining a chamber for a chemical substance that reacts chemically with said liquid to generate a fuel gas, a first chemical reaction space 3, and a second chemical reaction space 4.

The storage body 1 may desirably comprise a vessel 30 which may, for example, be partially or completely transparent when used in connection with the provision of a low pressure, small volume fuel gas supply having a gauge pressure of approximately 10 KPa or less. The body 1 may include an elastic vessel 11 such as, for example, a rubber balloon, for housing a catalytic solution 10 which may, for example, be an aqueous solution of malic acid or hydrochloric acid that has been adjusted in advance to a prescribed concentration. Elastic vessel 11 is attached to a hollow pipe 13 with a fixed seal, and hollow pipe 13 is provided with at least one opening 13a. Furthermore, one end of pipe 13 passes through a seal cover 15 and is joined with an external screw mechanism 12a. This screw mechanism 12a is pressed onto and joined to a hollow shaft 12 having a conduit 10b extending therethrough.

An inlet 10a to conduit 10b is located at one end of shaft 12 which is also provided with a movable seal part 12b. An elastic pipe member 12c, which may be in the form of a rubber pipe, is provided on the outer periphery of shaft 12 as shown. Shaft 12 is further provided with a aperture 12d disposed centrally of the member 12c. As can be seen viewing FIG. 1, the other end 12e of the hollow shaft 12 is closed.

Flow of solution 10 toward the react ion zone is controlled by opening and closing the valve mechanism provided by a needle part 12f at the lower end of shaft 12 working in conjunction with an opening in the upper wall of seat 12g as shown in FIG. 1. The lower end of the hollow pipe 13 is slidably engaged with seal member 31a, and the latter has a unitized constitution with the cover 31 that closes the vessel 30. And in this regard, seal member 31a is further provided with a passageway 31b for delivering the solution 10 to the storage body 2. Passageway 31b is further linked to a passageway 31c provided in a pipe 26. A flow constricting segment in the form of a narrowing part 26a is provided at the outlet of passageway 31c. Although it is not shown in the drawing, this narrowing part 26a may be in the form of a porous material that allows passage of gas or a fabric material that brings about the capillary effect.

Storage body 2 houses a gas generation member 20 that desirably may be in the form of a chemical substance that reacts chemically with solution 10 to generate a fuel gas. Storage body 2 may include a spring 22 pushing downwardly on member 20. Alternatively, although not shown in the drawings, a weight having the same function as spring 22 may be substituted for the latter, particularly if the application does not require operability in diverse orientations. Spring 22 presses on one end of member 20 via a sheet 21 working in conjunction with a cover 24 that is joined to vessel 30 by press fitting or through the use of screw threads using a seal member 23. The other end of the gas generation member 20 is seated on a sheet 25 that allows liquid such as the solution 10 to pass therethrough. As can be seen in FIG. 1, sheet 25 provides a partial boundary for a space 3 where the chemical reaction between the solution 10 and the chemical substance from member 20 takes place. Space 3 is linked to another space 4 by a porous sheet 26 provided with pores 26c, and thus the chemical reaction continues in space 4.

As shown, space 4 is in intercommunication with the internal space of the storage body 1, and the fuel gas generated in spaces 3 and 4 may be supplied to a fuel cell system via a supply outlet 300. A channel 40a within a porous resin member 40 is in communication with supply outlet 300 and directs the fuel gas toward the latter. Moreover, porous resin member 40 is arranged such that it does not allow the catalyst reaction liquid 10 to enter. Thus, solution 10 is prevented from leaving the interior of the device.

When the device of FIG. 1 needs to be filled with the solution 10, the closing of the needle part 12f should first be confirmed using the screw mechanism 12a. In this regard, as mentioned above, the part 12f works in conjunction with a hole in the upper part of seat 12g to permit flow of liquid 10 toward the reaction zone. Furthermore, if the catalytic solution 10, which may have been adjusted to a prescribed concentration in advance, is injected into the device under pressure, for example, using some sort of an injector or the like, the elastic pipe member 12c will be expanded by liquid pushing through the aperture 12d because of the pressure inside the hollow conduit 10b. Thus, the solution 10 flows into the empty channel 10c within pipe 13 which surrounds shaft 12. The elastic vessel 11 is then filled via the openings 13a.

To supply the solution 10 to the storage body 2, the needle part 12f is withdrawn from the hole in seat part 12g using the screw mechanism 12a. Thus the liquid 10 is allowed to flow from within vessel 11 via openings 13a and into channel 10c. The liquid then is free to flow through the hole in seat 12g so as to provide a continuous supply to the sheet 25 via the narrowing part (flow constricting segment) 26a and the linking passageways 31b and 31c at a supply rate prescribed in advance. Naturally, it is possible to stop the supply of the solution 10 if necessary with the screw mechanism 12a.

The solution 10 supplied from the flow constricting segment 26a passes through the sheet 25 so as to cause a chemical reaction with the chemical reaction member 20. Fuel gas is generated thusly. Since the generated fuel gas is sealed off from the outside by the cover sheet 21, the reaction solution 10 is actively prevented from permeating into the member storage space through the sheet 25 by the internal pressure of the storage body 2, and the result is that the chemical reaction continues at the interface of the sheet 25. In addition, in the first chemical reaction space 3, the size thereof is established as a function of the chemical reaction rate so that a constant concentration of the catalytic solution 10 is maintained in space 3. Furthermore, the device of FIG. 1 is characterized by a two space chemical reaction zone with the chemical reaction being continued in the second reaction space 4 that is linked to the first space 3. Moreover, the fuel gas that is generated passes through the gas permeable member 40 and is supplied from the channel 40a to an external system (not shown in the drawing) via the supply outlet 300. In addition, the device of FIG. 1 is made up, for example, of a transparent member such as plastic, whereby the supply of materials inside the device and the state of the reaction are visually confirmable.

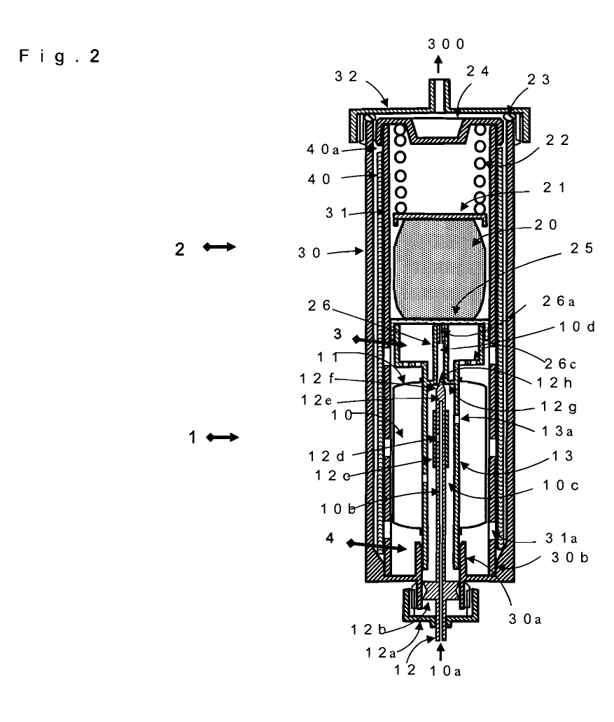

FIG. 2 is a cross-sectional view illustrating a second embodiment of a hydrogen gas generation and supply device that exemplifies the concepts and principles of the present invention. This second embodiment is one where the components of the fuel gas generation and supply device of FIG. 1 are structurally disposed in an aligned configuration as opposed to the side-by-side configuration shown in FIG. 1. The functioning of the device of FIG. 2 is exactly the same as the functioning of the device of FIG. 1. Therefore, the same element numbers are given to corresponding parts, and duplicate descriptions are omitted.

Since the mechanism that generates the gas according to this FIG. 2 is exactly the same as that of FIG. 1, as discussed previously, a description will be omitted, but the gas permeable member 40 shown in FIG. 1 is disposed instead at the periphery of the storage body 1 and the gas generation member storage body 2. However, the member 40 is provided in a space linked with the generated gas supply outlet 300, and has an identical function. In connection with this embodiment the position of the generated gas supply outlet 300 is not limited to the position shown in the drawing.

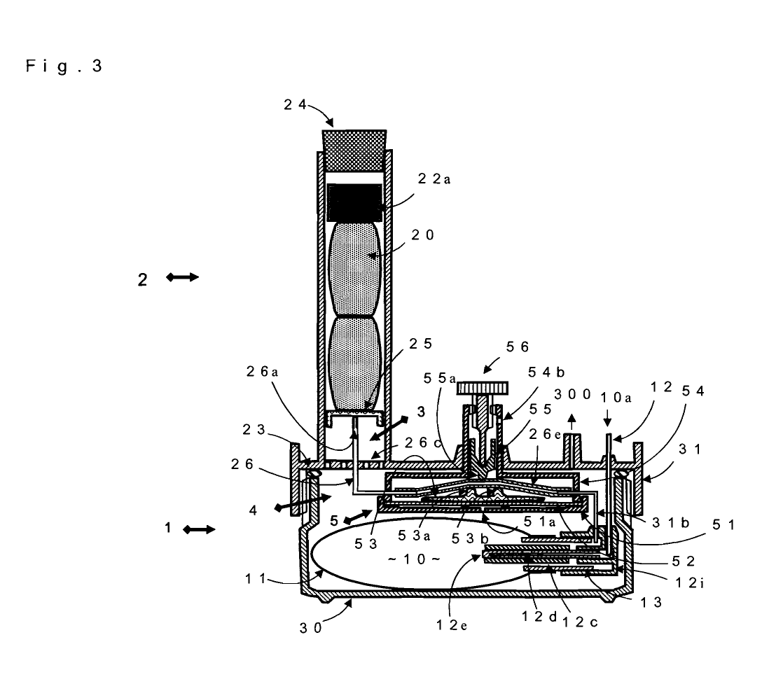

FIG. 3 is a cross-sectional view illustrating a third embodiment of a hydrogen gas generation and supply device that exemplifies the concepts and principles of the present invention. The gas generation and supply device of this third embodiment includes the same four major elements as the device of FIG. 1, namely, a reactive liquid storage body or container 1, a gas generation member storage body 2 defining a chamber for a chemical substance that reacts chemically with said liquid to generate a fuel gas, a first chemical reaction space 3, and a second chemical reaction space 4. However, in this third embodiment, a flow control mechanism in the form of a control device 5 is added to control the amount of the catalytic solution 10 supplied to the chemical reaction member 20 as a function of the pressure of the generated gas. Therefore, in FIG. 3, the same element numbers are given to corresponding parts, and descriptions of duplicate components are omitted.

The flow control mechanism 5 includes a diaphragm 52 such as, for example, a thin film rubber circular plate that is elastically deformable as a function of the generated gas pressure. Diaphragm 52 is constrained by a vessel 54 that is press fit into the cover 31 as shown, and the same is provided with a relief opening 54b. Device 5 also includes a vessel 51 provided with a pressure aperture 51a. On the diaphragm 52, there is a circular sheet 53 made up of, for example, a plastic disk provided with two rod shaped protruding parts 53a and 53b. The protruding parts 53a and 53b are in contact with an elastic pipe 26e, such as for example a rubber pipe, and the protruding parts 53a and 53b and the elastic pipe 26e are initially arranged and configured so that the pipe 26e is in a predetermined state of elastic deformation such as that shown in the FIG. 3. One end of pipe 26e is linked to the pipe 26 and the other end is linked to the passageway 31b. Furthermore, the elastic pipe 26e is coupled with a screw 56 via a plunger 55 that is desirably divided as shown in FIG. 3 to improve the centering of the same relative to the two protruding parts 53a and 53b. It is to be noted here that the plunger 55 might desirably be unitized for other applications. The pipe 26e is in contact with a movable rod shaped protruding part 55a that is part of plunger 55 and constitutes the “narrowing part” or “flow constricting segment” described previously. Thus, if the pressure of the generated gas increases, such pressure is communicated to the diaphragm 52 via pressure aperture 51a whereby diaphragm 52 is pushed toward the elastic pipe 26e which is thereby compression deformed and the amount of the liquid supply is limited. On the other hand, if the gas pressure drops, there is recovery from the compression deformation and the amount of liquid supply increases. Because an elastic deforming material is used, this mechanism functions adequately even at pressures of, for example, approximately 10 KPa.

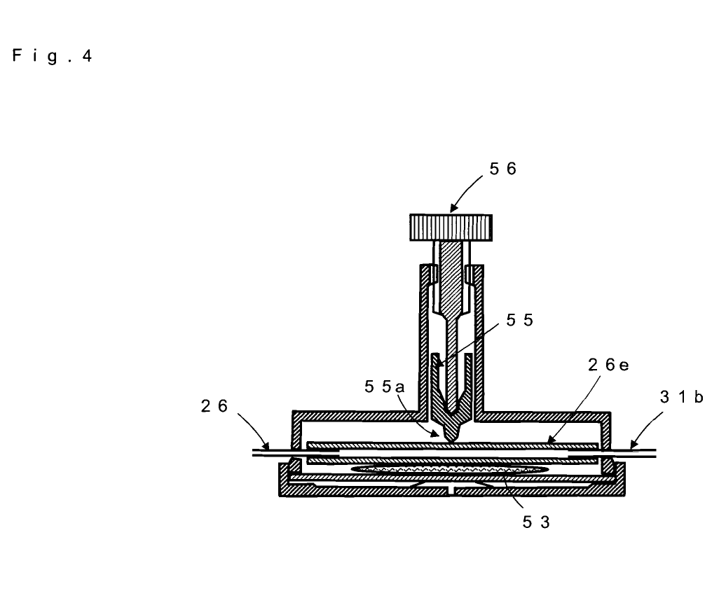

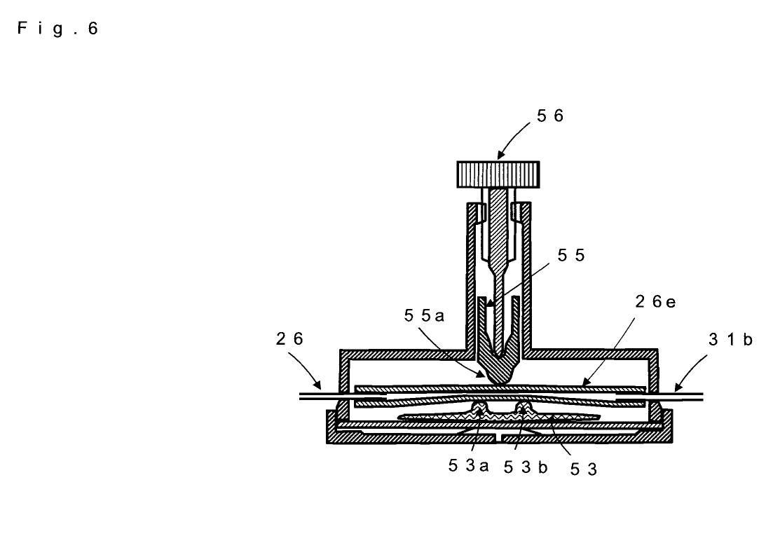

FIGS. 4, 5 and 6 show alternative embodiments of the control device 5. In other words, to make it possible to have a good response for precise control of the amount of fuel gas generated even with fuel gas pressures of approximately 10 KPa, for example, these devices provide a size and sensitivity corresponding to the fuel gas generation pressure required by the fuel cell system in connection with which the same are utilized. The important technical elements for making this possible based on the same constituent elements (conditions of size, materials used and the like) are the specifications of the compression deformation of the elastic pipe 26e, and for specific characteristics, these include “amount of compression deformation” and “compression deforming seal width.” As can readily be seen from FIGS. 4, 5 and 6, the “amount of deformation compression” decreases and “the compression deforming seal width” increases as one goes from FIGS. 4 to 5 and 6. In other words, the lower pressure side, higher responsiveness side and greater sealing are shown. Therefore, for example, with a system that permits a pressure of approximately 100 KPa for the generated gas pressure, it is shown that the range of applicability is extended even with the simple construction featured in FIG. 4.

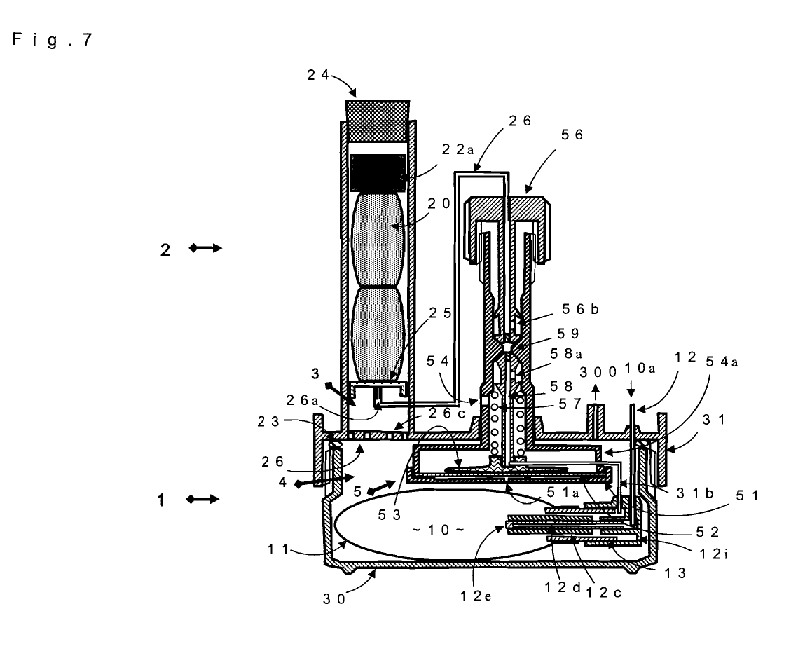

FIG. 7 is a cross-sectional view illustrating a seventh embodiment of a hydrogen gas generation and supply device that exemplifies the concepts and principles of the present invention. FIG. 7 shows yet another alternative form of the control device 5 that is similar to the control device 5 of FIG. 3 described previously. Therefore, the same element numbers are given to corresponding parts, and descriptions of duplicate components are omitted.

In this case the elastic pipe 26e constitutes the “narrowing means” or “flow constricting segment” described previously and the same functions are carried out with a spring 57 that is in contact with the circular sheet 53, a hollow shaft 58 that has the cover 54a on its periphery, and a movable seal. The hollow shaft 58 carries out the opening and closing of a seat 59 to thereby control the supply of the catalyst solution. The hollow part of the screw 56 is linked to the pipe 26 and the hollow part 58 is linked to the passageway 31b. Therefore, if the pressure of the generated gas increases, the diaphragm 52 pushes the hollow shaft 58 up and closes the seat 59. Thus, the supply of the solution 10 is shut off. On the other hand, when the pressure of the generated gas decreases, the diaphragm 52 is pushed down by the spring 57, and the solution 10 that has come via the opening 58a is supplied via the opening 56b to the linking pipe 26. The linked pipe 26 and passageway 31b are flexible, and, for example, may be fluorine pipes capable of handling the process conditions and having a dimensional configuration capable of dealing with movement.

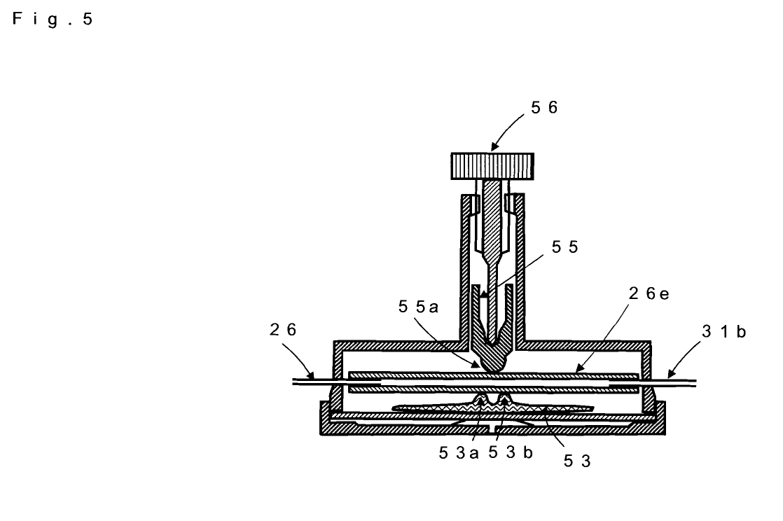

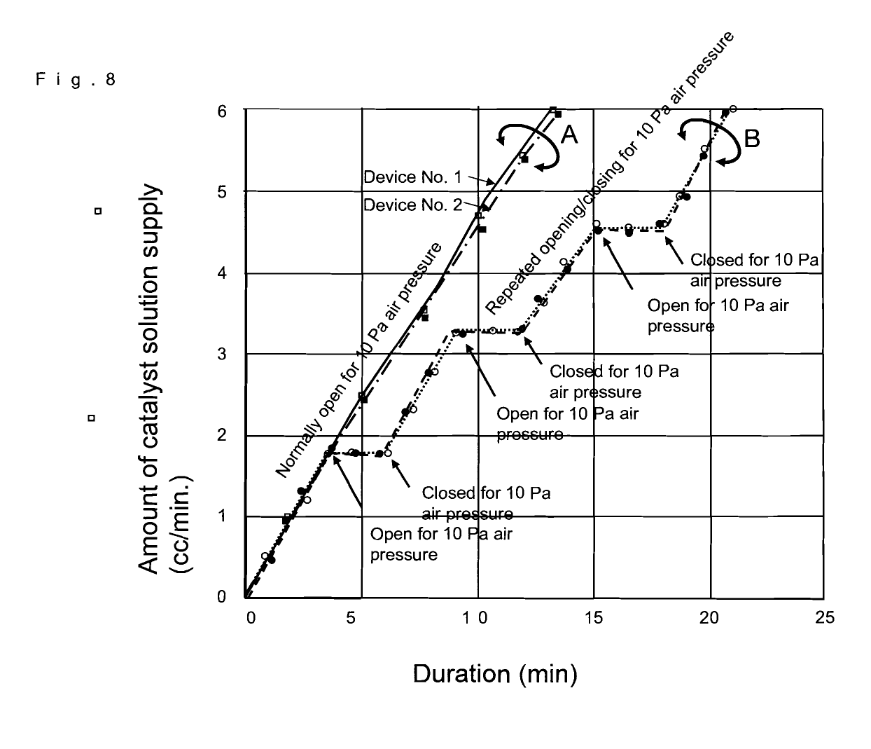

FIG. 8 shows test results that verify the basic functions of the hydrogen gas generation and supply device of FIG. 3. These data show that the supply rate for the solution 10 is constant (Graph A), this being an important requirement for maintaining a constant chemical reaction which is an important object of the present invention. These data also show the control state (Graph B) for the amount of fuel gas supplied at a very low pressure (for example, approximately 10 KPa). This test was carried out for a presumed 20 W class fuel cell system as was described previously, presuming a continuous supply of the catalytic solution of approximately 0.5 cc/min. Graph A also shows substantially the same amount of stabilized supply for two devices having different capacities (diaphragm sizes of 37 mm and 45 mm). In Graph B, a desired amount of fuel gas supply is turned ON and OFF by the ON and Off functioning of a pressure of approximately 10 KPa on the diaphragm for the two devices. Also, in the supply stop state in the results of visual observations, the leakage from the narrowing part 26a for both devices was zero in the range of this test. However, when the devices shown in FIGS. 4 and 5 were utilized, the solution was observed to ooze from the narrowing part 26a at approximately 10 KPa. This test was carried out for advance confirmation of whether the intended results were being obtained further upstream before suddenly carrying out fuel gas generation tests.

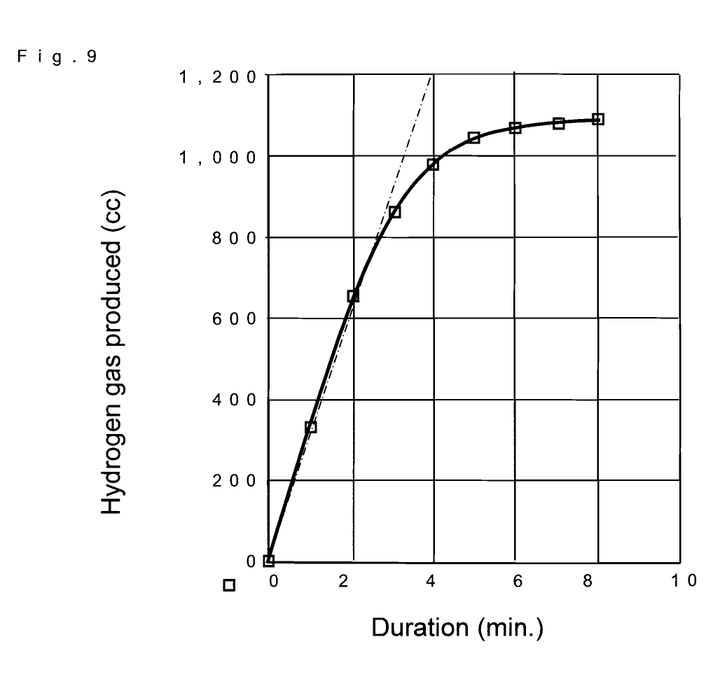

FIG. 9 shows a set of test results where a constant amount of fuel gas was generated continuously using a hydrogen gas generation and supply device as illustrated in FIG. 1. This device was constructed so as to contain sufficient chemicals to produce 0.5 g of hydrogen, and the size of the same was substantially twice that of a 100 yen lighter with a height of 8 cm, a width of 4 cm, and a depth of 2.2 cm. The test results were achieved using 3 cc of a 1 molar catalytic solution. In these data, it can be seen that the entire charge of chemical substance was depleted since the total fuel production of roughly 1.1 liters was equal to the amount calculated using chemical equations when 0.5 g of the chemical substance was used. In addition, the range for continuous generation of a constant amount of fuel gas was seen as being up to somewhat less than 80% of that, and this could be thought of as substantially giving the intended results. In addition, what has not been directly confirmed using an actual system for the control device with the very low pressure fuel gas described previously is a result of its not being possible to acquire such fuel cell systems immediately, but can be thought of as opening a path for the future through the results of these tests.

### Effects of the Embodiments

According the these embodiments, it is possible to supply the necessary amount of fuel gas at the required time in response to a generated gas pressure of, for example, approximately 10 KPa with a device that is small in size which can fit in the palm of the hand or even smaller, for example, of about the size of a 100 yen lighter, and which is inexpensive, safe and reusable, which is, as was mentioned previously, different from the fuel cell technology implemented in chemical plants. As a result, trial practical use can achieve a base of application possibilities for a variety of uses, and it can be assumed that an environment where completeness will be increased rapidly will come about. In addition, prototypes of the control devices shown in FIGS. 4 through 6 can actually be implemented in a device the size of a ten yen coin according to the application, and it can be assumed that the path to even further reductions in size has been opened.

### Other Embodiments

A solid fuel gas generating chemical substance was used in connection with the embodiments of FIGS. 1 through 3. However, the invention is not limited to this, and it is possible within the inventive scheme to use a liquid gas generating substance. In some cases it might even be easier to use a liquid substance than a solid one. The reason for this is that a liquid reactive substance might be supplied to the reaction zone in the same controlled manner (constant rate) as the catalytic solution to thereby achieve the required constant chemical reaction rate at the required time. This constant reaction rate, of course, is an important concept of the present invention.

Additionally, the control devices of FIGS. 4 through 6 have an elastic deforming member as a constituent member, which is the same as the concept based on the present invention, and it was possible to actually fabricate a device about the size of a 10 yen coin, as mentioned previously. Therefore, applications of the functions described previously have been made possible using the constituent element of an elastic deforming member in portable control devices that have a variety of forms.

Furthermore, another characteristic of the present invention is that the location where the narrowing part 26a is disposed is a position in direct contact with the site of the chemical reaction as shown in FIGS. 1 through 7. Furthermore, structural examples thereof were in the form of a fabric or porous member described previously, but as a method for continuously and stably supplying a minute amount of the catalytic solution of 0.5 cc per minute or less besides including the capillary effect described previously, there is the possible inclusion of a supply means using a means such as an ink jet. In addition, the cover 24 shown in FIGS. 1, 3 and 7 is a press fit system for low pressure applications near normal pressure, but types that are closed and tightened using an O-ring, which is a typical method, or by a screw that uses a sealing material such as packing are possible.

I claim:

1. A fuel gas generation and supply device comprising:
a reactive liquid storage container;
a storage body defining a chamber for a chemical substance that reacts chemically with said liquid to generate a fuel gas;
a liquid supply system disposed and arranged for delivering said liquid from the container to the chemical substance in the chamber at a fixed rate, said system including an outlet and a flow constricting segment to control the amount of said liquid supplied to the chemical substance; and
a fuel gas delivery system.

2. A fuel gas generation and supply device as set forth in claim 1, and a unidirectional liquid introduction system for introducing reactive liquid into said liquid storage container.

3. A fuel gas generation and supply device as set forth in claim 1, wherein said flow constricting segment comprises a fabric providing capillary flow disposed on an inside surface of said outlet.

4. A fuel gas generation and supply device as set forth in claim 3, wherein said fabric comprises a porous material having gas permeability.

5. A fuel gas generation and supply device as set forth in claim 1, wherein said flow constricting segment comprises a porous material having gas permeability disposed on an inside surface of said outlet.

6. A fuel gas generation and supply device as set forth in claim 1, wherein said flow constricting segment comprises a flow restricting element disposed at said outlet and having a surface area smaller than the internal transverse cross-sectional area of said outlet.

7. A fuel gas generation and supply device as set forth in claim 1, wherein said storage body is at least partially defined by a liquid permeable member in communication with said chemical substance, and wherein said liquid supply system supplies said liquid to the permeable member.

8. A fuel gas generation and supply device as set forth in claim 7, further comprising a reaction space disposed on the opposite side of the liquid permeable member from the chemical substance, said space being linked to said outlet and being adapted to retain liquid therein but allow gas to pass therethrough.

9. A fuel gas generation and supply device as set forth in claim 8, said fuel gas delivery system being linked to said space.

10. A fuel gas generation and supply device as set forth in claim 8, and a second chemical reaction space linked to said first mentioned chemical reaction space, said second space having a larger volume than said first mentioned space.

11. A fuel gas generation and supply device as set forth in claim 1, wherein said flow constricting segment includes a flow control mechanism disposed so as to control the flow of liquid in an elastic liquid line leading to said outlet.

12. A fuel gas generation and supply device as set forth in claim 11, wherein said flow control mechanism includes an external operator for manually controlling the flow of said liquid in said line.

13. A fuel gas generation and supply device as set forth in claim 11, wherein said flow control mechanism includes a deformable element that is deformable in a direction to apply external pressure to said line in response to the pressure of the generated fuel gas.

14. A fuel gas generation and supply device as set forth in claim 12, wherein said flow control mechanism includes a deformable element that is deformable in a direction to apply external pressure to said line in response to the pressure of the generated fuel gas.

15. A fuel gas generation and supply device as set forth in claim 1, wherein said flow constricting segment comprises a flow restricting element disposed at said outlet and a flow control mechanism disposed so as to control the flow of liquid in an elastic liquid line leading to said outlet.

16. A fuel gas generation and supply device comprising:
a reactive liquid storage container;
a storage body containing a liquid chemical substance that reacts chemically with said reactive liquid to generate a fuel gas;
a reaction zone where said liquids are brought into contact with one another;
a liquid supply system disposed and arranged for delivering at least one of said liquids to said reaction zone at a fixed rate, said system including an outlet and a flow constricting segment to control the amount of said liquid supplied to the zone; and
a fuel gas delivery system.
